(19) United States
(12) Patent Application Publication
(10) Pub. No.: US 2013/0342342 A1
(43) Pub. Date: Dec. 26, 2013

(54) INTELLIGENT SAFETY DEVICE TESTING AND OPERATION

(71) Applicants: John Sabre, Edina, MN (US); Lynn Sabre, Edina, MN (US)

(72) Inventors: John Sabre, Edina, MN (US); Lynn Sabre, Edina, MN (US)

(73) Assignee: Hunter Capital Management Group, LLC, Edina, MN (US)

(21) Appl. No.: 13/528,042

(22) Filed: Jun. 20, 2012

(51) Int. Cl. G08B 29/12

(52) U.S. Cl. 340/509

(57) ABSTRACT

Systems and methods for intelligent operation and testing of backup-powered safety devices such as exit signs, emergency lights, smoke alarms, and like devices are generally disclosed herein. In some embodiments, an indicator is used to provide a display of the operational status of the safety device, as well as a testing or charging procedure status for a backup power source. The indicator may be used to provide a definitive indication of whether the testing or charging procedure was conducted, and whether such testing or charging procedure either failed or succeeded. In further embodiments, a single indicator provides each of the operational, testing, and charging status indicators for predefined periods of time using a single visible indicator display provided within the safety device.

### TECHNICAL FIELD

Embodiments pertain to the use and operation of safety devices and equipment. Some embodiments relate to charging, testing, and operational techniques and configurations used with safety devices and equipment providing a backup power source such as exit signs and emergency lights.

### BACKGROUND

Safety devices such as illuminated exit signs, emergency lights, smoke or carbon monoxide detectors, and the like are commonly placed in buildings and other locations to denote emergency exits, illuminate egress means, provide warnings or instructions, and to generally assist humans in various emergency conditions. Many of these safety devices require a power source to operate. Electrical power may be provided from an electrical system, such as an always-on alternating current (AC) electrical system, with a redundant power source such as a battery backup provided within the safety device to offer power in the case of an electrical system failure.

Various fire, building, health, and safety codes require backup-powered safety devices to be tested at regular intervals to ensure that the backup power source functions correctly. For example, National Fire Protection Association (NFPA) 101, known as the “Life Safety Code®,” requires that emergency illumination devices (e.g., illuminated exit signs and emergency lighting devices) having a battery backup be periodically tested. Specifically, compliance with NFPA 101 requires testing at 30-day intervals for not less than 30 seconds, and testing at annual intervals for not less than 90 minutes.

NFPA 101 provides a testing exception for self-testing/self-diagnostic, battery-operated emergency illumination devices. Specifically, a device that automatically performs a minimum 30-second test and diagnostic routine at least once every 30 days and indicates failure by a status indicator is exempt from performing the 30-day functional test, provided a visual inspection is performed of the status indicator at 30-day intervals. Such a failure status indication, however, may be misleading or not fully indicative of the true status of the device. For example, if the device has some internal failure, the device may not be able to generate or display a “failure” status that can be observed by a user.

### BRIEF DESCRIPTION OF THE DRAWINGS

FIG. 1 provides an illustration of an illuminated exit sign and emergency light safety device according to an example embodiment;

FIG. 2A provides an illustration of an illuminated exit sign safety device according to an example embodiment;

FIG. 2B provides an illustration of components provided within a housing of an illuminated exit sign safety device according to an example embodiment;

FIG. 3 provides a block diagram illustrating components of a backup powered safety device according to an example embodiment;

FIG. 4A provides a flowchart illustrating operations for determining safety device battery charging conditions according to an example embodiment;

FIG. 4B provides a flowchart illustrating operations for performing safety device battery charging techniques according to an example embodiment;

FIG. 5 provides a flowchart illustrating operations for providing safety device operational indications according to an example embodiment; and

FIG. 6 provides a flowchart illustrating a method for providing safety device indications according to an example embodiment.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure illustrates techniques and configurations to enable charging, testing, maintenance, and operation verification of backup-powered safety devices. These techniques may be implemented in a safety device for compliance with various operational requirements and standards, such as fire and safety codes that require certain actions, tests, responses, and states to occur with the safety device.

In some embodiments, an indicator (such as one or more LED display indicators) may be provided within or adjacent to the safety device to indicate a status of charging, testing, failure, or correct operation of the safety device. Instead of providing an indicator that only displays if the device is able to detect a failure condition, the indicator may be used to provide a positive indication of whether the device is properly functioning, and whether a test has successfully occurred. This indicator may provide a visible display to a human at certain intervals or in response to testing operations. In further embodiments, the indicator may be provided by an electronically provided indicator that is communicated to a monitoring or control system.

In some embodiments, a single user-visible display indicator is provided to generate a display of a safety device status, including device operation status and backup power status. The single display indicator may be provided through use of a single lamp, such as an LED indicator lamp. Various patterns may be displayed through use of the single display indicator to convey information. For example, if the display indicator is lit “solid” for a period of time or until cleared, then this may indicate a battery issue or other internal failure. If the display indicator is flashing, then this may indicate a testing status. Various flashing patterns may be provided with a single display indicator to indicate specific testing, charging, or other operational statuses.

In some embodiments, a switch or other manual control may be provided to control various operations of the safety device, such as initiating a test of the safety device. For example, a battery test push button may be provided on, within, or adjacent to the housing of the safety device to allow a human user to initiate a battery testing procedure. Additionally, the battery test button when pressed in a particular sequence or operation may allow the user to initiate short (30 second) or long (90 minute) battery operated tests. The user may initiate these tests any time.

In some embodiments, various battery charging techniques are provided to charge rechargeable batteries used as a backup power source in the safety device. The charging techniques may be designed to extend battery life while keeping the backup power supply ready for use. The various charging operations may occur in an automated fashion, or may be controlled by the switch or other manual control. Status of the charging operations may also be indicated through use of the display indicator.

### Example Exit Sign Safety Device

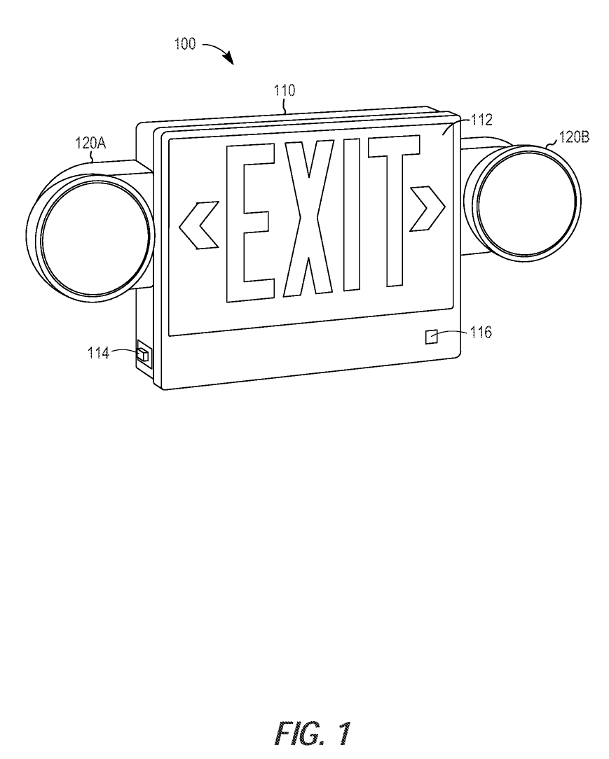

FIG. 1 provides an illustration of an illuminated emergency light and exit sign safety device 100 implementing techniques and configurations according to some example embodiments. As depicted, the safety device 100 includes a generally rectangular housing 110 made of a durable material such as molded plastic or metal. The safety device 100 provides illuminated “EXIT” letters 112, and may be mounted on a wall or suspended from a location to indicate emergency egress or exits. The illuminated “EXIT” letters 112 may be provided by a Light Emitting Capacitor (LEC) display, an Electroluminescent (EL) display, a Light Emitting Diode (LED) display, an Electronic Ink display, or other powered illuminated display.

As further illustrated, the housing 110 may expose features used in connection with operational verification and testing of the safety device 100. The depicted features of FIG. 1 include a visible display indicator 116 and a control 114. For example, the control 114 may comprise a push button switch that is configured to perform one or more tests or control defined operations when toggled. The visible display indicator 116 may comprise a LED lamp, for example, that is configured to illuminate and provide a visible display of operational status of the safety device 100, which may include backup power supply status, testing status, charging status, and error status. In other embodiments, a non-visible indicator such as an audible indicator may be provided to indicate operational status.

The housing 110 is further coupled to emergency lights 120A, 120B which are configured to illuminate in case of an electrical system outage or other detected or signaled emergency condition. The emergency lights 120A, 120B may be configured to consume the backup power supply of the safety device 100 if the primary power source is not available. In some embodiments, the backup power supply of the safety device 100 includes a separate backup power supply for the emergency lights 120A, 120B and a display of “EXIT” letters 112. In some embodiments, the safety device 100 may provide an additional always-on or emergency-triggered downlight (not shown) on one side (e.g., a bottom-facing side) of the housing 110

The safety device 100 may be configured to primarily operate on an always-on primary electrical system power connection. For example, a default state of the safety device 100, while powered from the primary electrical system, may be to have the “EXIT” letters 112 illuminated but the emergency lights 120A, 120B not illuminated. In an emergency state, such as during failure of the primary electrical system, the “EXIT” letters 112 will remain illuminated while the emergency lights 120A, 120B will become illuminated. Power during emergency operations may be provided from a backup power source such as a battery or capacitor (not shown) provided within the housing 110, or an alternate power source provided external to the safety device 100.

As would be understood, FIG. 1 provides an illustration of one configuration of an illuminated exit sign and emergency light safety device, while a variety of other configurations and designs may be embodied. For example, the housing shape and style of the illuminated exit sign may vary depending on jurisdictional safety requirements and codes. Likewise, the lighting requirements and operational times for the emergency lights 120A, 120B may vary depending on jurisdictional safety requirements and codes.

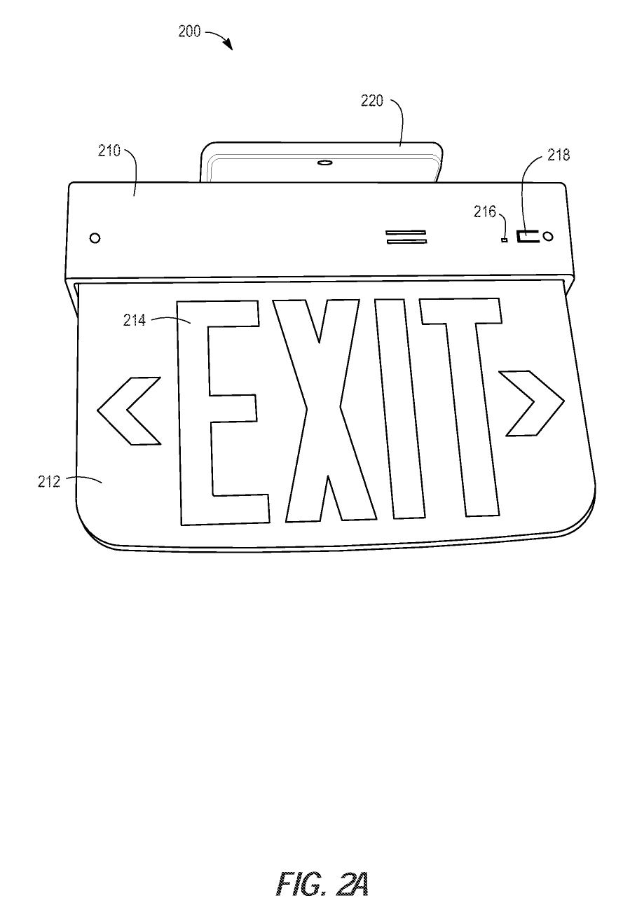

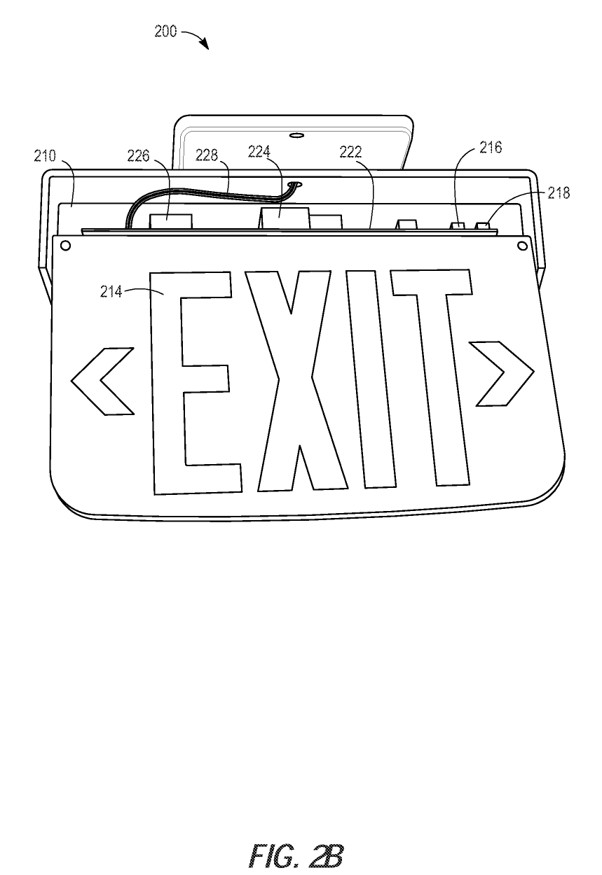

FIG. 2A provides an illustration of an illuminated exit sign safety device 200 implementing techniques and configurations according to some example embodiments. As depicted, the safety device 200 provides an alternate shape and configuration from safety device 100 in FIG. 1, although either shape of safety devices may be used to provide an illuminated exit sign display in a building.

The safety device 200 includes a generally rectangular housing 210 that is coupled to an exit sign display 212, the exit sign display 212 including a set of illuminated “EXIT” letters 214. The rectangular housing 210 is coupled to a mounting component 220 for mounting on a ceiling or other structure adjacent to or above an exit, for example.

The rectangular housing 210 may house a series of electric-powered components and controls, including a backup power supply and processing circuitry (depicted in more detail in FIG. 2B). The rectangular housing 210 may be configured to expose certain electrical components for user interaction and perception, such as a visible display indicator 216 and switch control 218.

FIG. 2B provides an illustration of some of the electric-powered components and controls included within the illuminated exit sign safety device 200, provided with techniques and configurations according to an example embodiment. Specifically, FIG. 2B provides an illustration of the safety device 200 also depicted in FIG. 2A, but with a portion of the housing 210 removed to expose the internal components.

As depicted, a circuit board 222 providing at least one microprocessor (not shown) and other electronic components is provided within the housing 210 of device 200. The display indicator 216 and the switch control 218 are each coupled to the circuit board 222, and operations of each of the display indicator 216 and switch control 218 are facilitated through logic executed by one or more components of the circuit board 222 (e.g., a microprocessor). The circuit board 222 is coupled to a backup power source 224, for example, provided by one or more batteries located within the housing 210. The circuit board 222 is further coupled to a primary power source through an alternating current (AC) converter 226, which receives AC power from the primary power source through power cable 228.

In accordance with the operations described herein, the display indicator 216 and switch control 218 may facilitate user operation, control, and observation of the exit sign safety device 200. For example, the display indicator 216 may illuminate or flash to indicate certain device statuses or the results of device operations (such as a test of backup power source 224). The switch control 218 may be depressed by a user to initiate manual safety device operations, such as manually launching or cancelling a test of backup power source 224, or to clear a status indicator provided from display indicator 216.

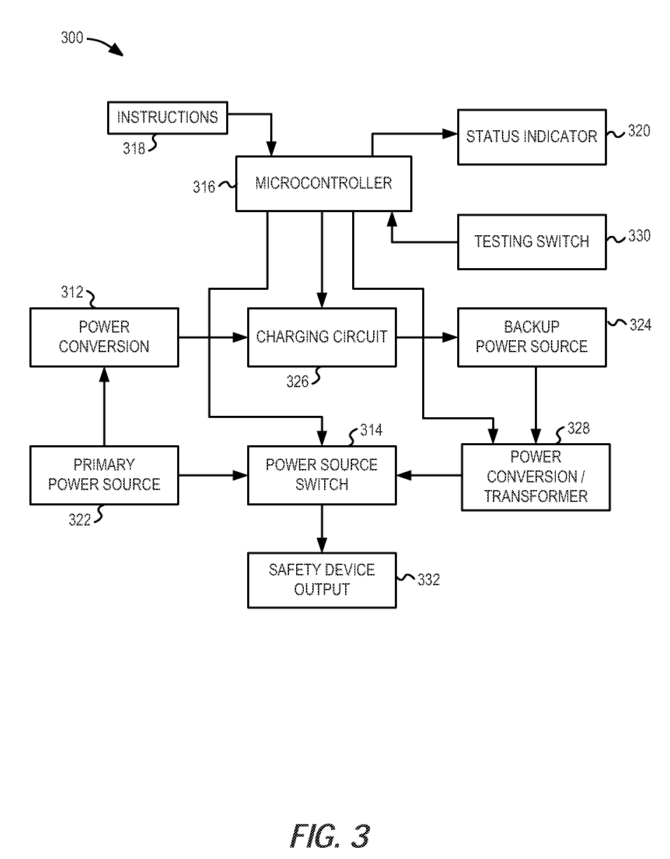

FIG. 3 provides a block diagram illustrating the components of a backup-powered safety device 300 according to an example embodiment. As shown, the safety device 300 includes a primary power source 322 to obtain electrical power. The electrical power received from primary power source 322 is provided to a power conversion component 312, which may convert or condition the electrical power from the primary power source 322 into a format usable by the electronic components of the safety device 300 (e.g., from 120 volt or 220 volt alternating current to 12 volt or 5 volt direct current (DC)). The power output from the charging circuit 326 may be used to charge the backup power source 324.

The safety device 300 further provides a power source switch 314 which is operable to switch between use of the primary power source 322 and a rechargeable backup power source 324 (e.g., a battery). For example, the power source switch 314 may be configured to automatically switch to power from the backup power source 324 upon failure of the primary power source 322. Likewise, the power source switch 314 may be instructed to switch to power from the backup power source 324 during a safety device test or other directed consumption of the backup power source 324. The power produced from the backup power source 324 may be provided in connection with a power conversion component 326. The power conversion component 326 may include a transformer or other mechanism to convert or condition the electrical power from the backup power source 324 into a format usable by the safety device 300.

Operations conducted within the safety device 300 may be controlled by programmed processing circuitry, such as a microcontroller 316 configured to execute a plurality of instructions 318. The microcontroller 316, for example, may be configured to provide control of the power source switch 314, a charging circuit 326, a status indicator 320, and a power conversion component 328 from the backup power source 324. The microcontroller 316 also may be operably coupled with testing switch 330 to receive commands provided by user interaction with the testing switch 330.

The microcontroller 316 may provide control of the charging circuit 326 to detect or determine when the backup power source 324 should be charged. When the backup power source 324 should be charged, the microcontroller 316 may cause the charging circuit 326 to provide power from the primary power source 322 to charge the backup power source 324. The microcontroller 316 may further implement certain charging schedules and algorithms with the charging circuit 326 for recharging the backup power source 324.

The microcontroller 316 may also be operably coupled to a status indicator 320 used to provide an indication of device operational status (including in some embodiments testing, charging, operational, and power status). For example, a status indicator 320 that provides a visible display indicator provided by a LED lamp may be controlled by the microcontroller 316 to provide certain displays (e.g., a blinking status, a solid on or off status, and the like). Likewise, a non-visible indicator such as an audible indicator may be used to provide various status indicators.

The microcontroller 316 may be operably coupled to other output controls that provide some or all operations of the safety device 300. For example, in a smoke alarm, this output may control the audible or visible indications provided to warn of the fire. In an emergency exit sign or emergency lighting device, the safety device output 332 may control the illumination provided by the sign or device. In a security system device, the safety device output 332 may control any number of audible, visible, or perceptible outputs.

The microcontroller 316 may be operably coupled to a testing switch 330 which provides the ability for user interaction with the safety device 300 and the various testing operations. For example, the microcontroller 316 may be configured to detect user interaction with the testing switch 330 to switch among various testing or operational modes. The testing switch 330 may also be used to instruct the microcontroller 316 to clear various status indicators being provided with status indicator 320.

### Battery Charging Techniques

In some embodiments of the safety devices described herein, rechargeable batteries are provided as a backup power source. Various charging techniques may be applied to the rechargeable batteries by the safety device to maximize battery life, usage times, performance, reliability, or other characteristics of the batteries or safety device.

In one embodiment, one or more nickel-metal hydride (NiMH) rechargeable batteries are provided as the backup power source. NiMH battery technology may be suited for deployment in certain safety devices, due to being reliable, having high energy density, and not exhibiting a battery “memory” effect associated with some battery technologies that can cause a battery to lose its maximum energy capacity after being partially discharged.

Specifically, in one charging technique implemented by an example safety device, the one or more NiMH batteries are charged slowly to reduce battery temperature effects and maximize the battery life. Other charging techniques implemented by the safety device may monitor and control usage of the rechargeable batteries to maximize charge. For example, when first installed, the device may be configured to not operate on battery power for a determined period of time, such as for up to 18 hours, to complete a full charge.

Implementation of the battery charging techniques may be provided in connection with microprocessor control within the safety device. For example, a microcontroller and accompanying comparator may be programmed to monitor battery voltage and measure accumulated charging current (e.g., in milliamp (mA) seconds), and compare the value to some determined threshold. The microcontroller may also initiate various checks on battery status and track battery usage to determine which charging technique to implement.

In some embodiments, for battery longevity and power savings, the battery is not continuously trickle charged, but is charged according to specific detected conditions. In addition, in some embodiments the safety device does not implement the use of fast charging algorithms because fast charging algorithms may allow the battery temperature to rise, reducing battery life. Rather, in one implementation, the safety device provides slower charge rates, according to specific detected conditions, to preserve battery life.

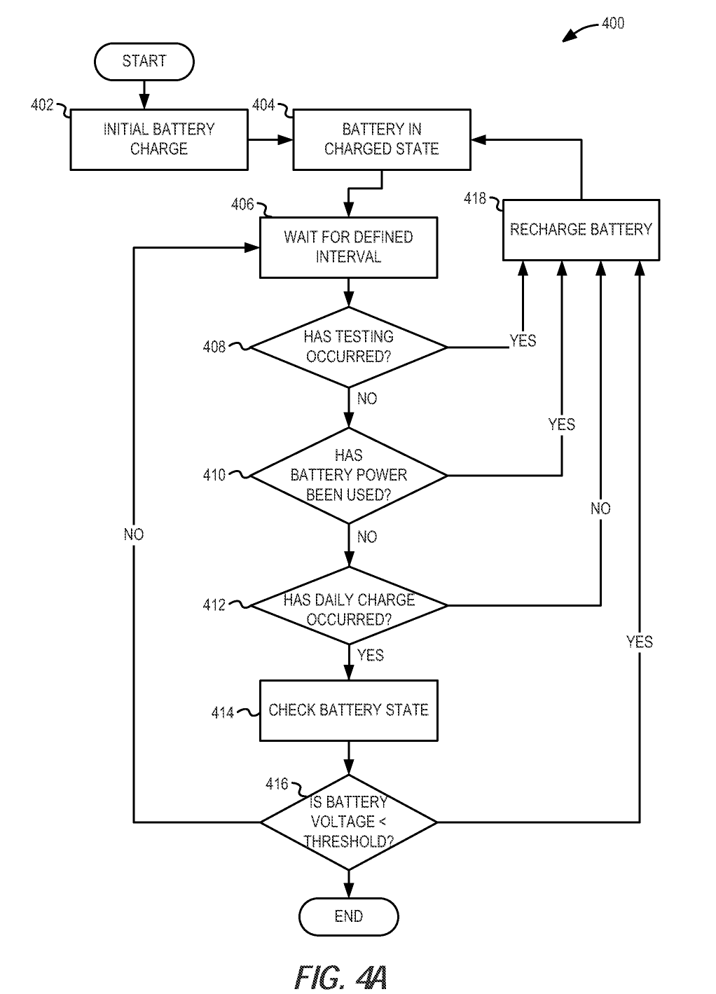

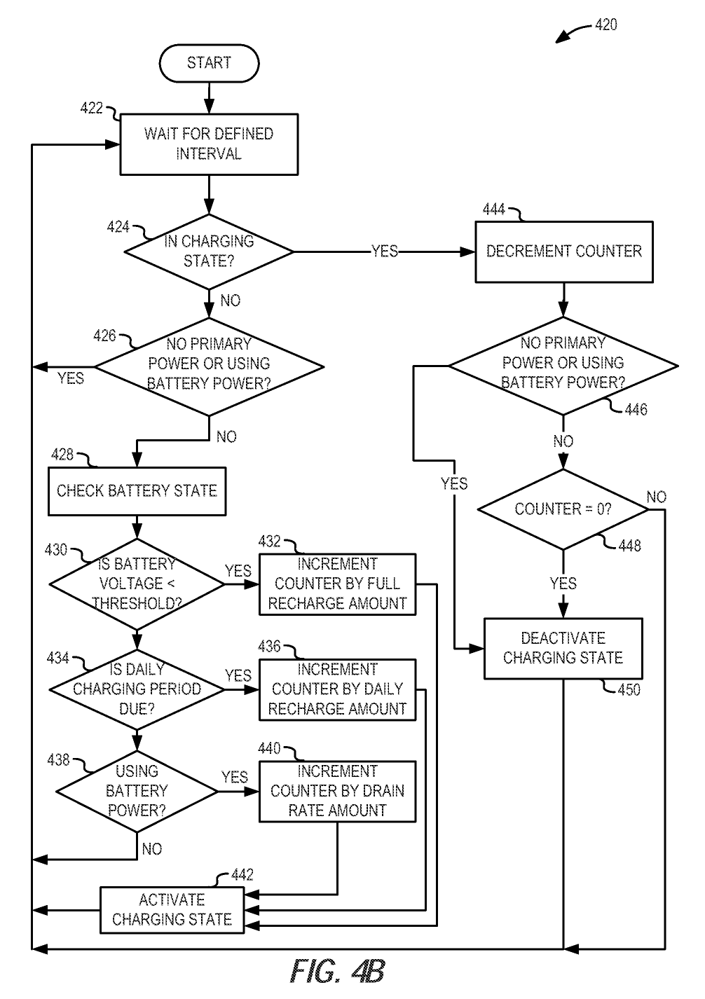

FIG. 4A provides an illustration of a flowchart 400 for determining battery charging conditions in accordance with some embodiments. As illustrated, a battery is placed into a charged state with an initial charge (operation 402). This may occur as a result of a user indication (e.g., a depressed switch) that battery installation or replacement has occurred, or logic that detects when a battery installation or replacement has occurred.

After the initial charge, the battery will be in a charged state (operation 404). The charging determination will wait for a defined interval of time (operation 406) before performing one or more checks to determine whether to perform a recharge battery operation (operation 418). In some embodiments, a battery check sequence will occur at a determined interval of time, such as every second or every 5, 10, 30, or 60 seconds. It will be apparent that the following battery check sequence may occur more or less often, or in response to detected events or conditions in the safety device.

The battery check sequence may be adapted to perform the recharge battery operation 418 in response to various operational and usage scenarios. For example, the battery may be re-charged to account for power loss after a battery testing (in response to decision 408) or battery backup power usage (in response to decision 410). Additionally, a daily “top off” charging may occur (in response to decision 412), for example for 10 to 15 minutes (or for a calculated period of time), to account for the battery load and self discharge. Or, if a battery state check (operation 414) indicates that battery voltage has dropped below a minimum threshold (in response to decision 416), a battery recharge may be initiated. The recharge battery operation 418 may be a variable or fixed charge length, for example performed for a calculated period of time based on estimated depletion of the battery.

Thus, FIG. 4A provides an illustration of four scenarios where the battery may automatically be recharged: (1) Daily for “top off” charging (decision 412); (2) after battery operation testing (decision 408); (3) after battery operation from loss of the primary power source, such as loss of AC power (decision 410); and (4) if the battery voltage is sensed to be too low (decision 416).

FIG. 4B provides an illustration of a flowchart 420 of operations for performing a slow-charge safety device battery charging technique in accordance with some example embodiments. FIG. 4B depicts the use of a counter used to determine the occurrence and duration of a charging state. As explained below, a counter with a high value is established to determine the duration of a charging operation, as the counter is decremented during a charging state. This counter may be provided, for example, as a representation of the amount of charge over a period of time needed to recharge the battery. For example, the counter may provide a representation of a “milliamp-second” measurement “MA-SEC” where MA-SEC=CURRENT(MA)*TIME(SEC).

The flowchart 420 provides illustration of a sequence of operations, similar to the operations depicted in FIG. 4A (and which may be used in combination with or in substitution of the operations depicted in FIG. 4A). As illustrated, the battery check and charging operations wait for or are otherwise initiated at a defined interval (operation 422). If the safety device or its backup battery is not in a charging state (from decision 424), then operations will be conducted to perform an evaluation whether a charging state should begin (and the amount to increment the counter). If the safety device or its backup battery is in a charging state (from decision 424), then operations will be conducted to decrement the counter (operation 444) and perform an evaluation whether the charging state is complete.

The evaluation whether a charging state should begin (and the amount to increment the counter) may be based on a verification of whether no primary power is available in the safety device or whether the safety device is using battery power (operation 426). If either of these conditions is true, then the charging state will not proceed, but instead will be delayed for at least the defined interval (operation 422). If these conditions are false, then conditions for the charging state will be evaluated, including a check of the battery state (operation 428). Evaluation of these conditions will either result in counter incrementing (operations 432, 436, 440) and activation of a charging state (operation 442), or return to wait for the defined interval (operation 422).

A verification of battery capacity levels may be performed. This may include performance of battery measurements. For example, if the battery voltage is equal or greater than a determined threshold (decision 430), then a charging state will not be indicated as a result of battery measurements. If the battery voltage is less than the determined threshold (decision 430), then a charging state may be initiated. The counter (e.g., MA-SEC) may be incremented to a full recharge amount (operation 432) or other maximum amount, for example to achieve a full re-charge upon activation of the charging state (operation 442).

A verification of a charging period based on a period of time (for example, a daily charging period) may be performed. For example, if a daily charging period is due (decision 434) as a result of determining that at least 24 hours have passed since a previous charge, then a charging state may be initiated. The counter (e.g., MA-SEC) may be incremented to a daily recharge amount (operation 436) or other amount, for example to achieve a re-charge from the charging state (operation 442) based on the estimated usage per day or since the last charging event.

A verification of charging based on battery usage (for example, if a testing procedure or a backup usage event has occurred) may be performed. For example, if the safety device has consumed any battery power (decision 438) since the last charge, then a charging state may be initiated. The counter (e.g., MA-SEC) may be incremented by a drain rate amount (operation 440) or other amount, for example to achieve a re-charge from the charging state (operation 442) based on an estimated usage during the battery usage state.

Returning to the scenario where the safety device is in a charging state (decision 424), a counter (e.g., the MA-SEC counter) may be decremented (operation 444) for each evaluation of the charging state. If no primary power is available or if the safety device is using battery power (decision 446), then the charging state is deactivated (operation 450). If the primary power is available and the device is not using battery power (decision 446), then the charging state is currently being performed. A check is performed to determine whether the counter is decremented to zero (decision 448), where if zero the charging state may be deactivated (operation 450). If the counter remains greater than zero (decision 448), then no further action is taken and the operational flow will return to wait for the defined interval (operation 422).

Additional operations may be performed or substituted for the operations and decisions illustrated in FIGS. 4A and 4B. Such operations and decisions may include checks whether a battery is disconnected, or whether a condition of the safety device or the primary or secondary power supply in the safety device has changed. Upon occurrence or detection of such events, the charging operations and the counter may be activated, deactivated, reset, or adjusted as appropriate for a detected state.

Although the preceding operations were described with reference to charging operations applied to rechargeable NiMH batteries, a variety of other rechargeable battery types may be used. For example, rechargeable batteries such as lithium-ion (Li-ion), Nickel Cadmium (NiCd), rechargeable alkaline, or other types of rechargeable battery types may be used in connection with the charging techniques described herein. Further, the charging techniques may be modified to suit the particular battery type. In other embodiments, the charging techniques may be configured for use with capacitors in addition or in substitution of rechargeable batteries.

### Use of Backup Power Source

In some embodiments, the safety device may be configured to provide various techniques to extend the use of the backup power source. For example, when the primary power source fails and the backup power source is consumed, the safety device may enable or disable various components in an attempt to extend available power and runtime of the backup power source. The safety device may be configured, however, to perform backup power testing at full power consumption rates when powered by the primary power source.

As one example of a technique to extend use of a backup power source, a power-consuming component such as a light or other illuminated component may be configured to alternate between full power consumption and decreased power consumption states when consuming the backup power source in a non-testing state. This may allow the illuminated component to decrease its rate of battery consumption, provided that the illuminated component produces a display that meets or exceeds minimum illumination standards.

Likewise, to decrease its rate of battery consumption, the safety device may factor surrounding light levels in determining the amount of power and light output (and the required usage of the battery) needed to adequately power illuminated components. The safety device may include detection capabilities to determine the amount of ambient light and the amount of illumination needed to provide a sufficient output of the safety device (to satisfy safety standards or code requirements). The safety device may use these detection capabilities to reduce power consumption and draw only necessary levels of power.

For example, the safety device may include a photo sensor (mounted within, adjacent to, or outside the device) to detect the amount of ambient light. As the photo sensor detects low ambient light levels, the amount of illumination provided by the safety device output can be increased. Likewise, as the photo sensor detects high ambient light levels and a bright environment, the amount of illumination can be decreased. The output of the photo sensor or other detection component may be factored by a coupled power consumption module, algorithm, or other processing functionality. The power consumption module may control power consumption of powered components providing safety device functionality based on the detected amount of ambient light by the photo sensor.

The amount of illumination may also be dependent on whether the primary or secondary power source is being consumed, to implement power conservation as appropriate for a battery power source. Information related to the amount of ambient light or conservation settings may also be provided from external sources or sensors (such as from a building control system).

Turning off a display or reducing the light output of the safety device may result in an increase of the usable life of the display, and reduced power consumption from both primary and secondary power sources. The detection algorithm used to reduce the amount of illumination may also consider additional factors in addition to ambient light, including time of day, testing or operational schedules, a measured amount of remaining backup power, or user settings. Other detection functionality and logic may be provided to ensure that the safety device output meets or exceeds applicable codes and standards.

For an exit sign safety device, if the primary power source (e.g., AC power) is on, and the exit sign is in a normal operation state, the exit sign may be configured to consume full power from the primary power source in providing its illuminated state. If the AC power is on, but the exit sign is in a testing state, the exit sign is configured to consume full power from the backup power source in providing its illuminated state. However, if the primary power source is interrupted, and the exit sign must use the backup power source, the device may be configured to reduce the illumination of the “EXIT” letters. For example, the illumination device may switch between full brightness to slightly dimmer during a time interval, such as alternating every one second, or performing operations with lesser brightness every couple of seconds.

Various backup power usage indications may also be provided by the safety device in connection with use of the backup power source. For example, an illumination device may flash at an interval to indicate that the backup power source is being used. Likewise, an audible indicator (such as a beep, chirp, or recorded speech) may be provided to indicate to a user that a backup power source is currently in use. An indicator may also be used to show or otherwise communicate the amount of estimated battery power remaining at the current or projected usage rate.

### Indicator Display

In some embodiments, an indicator may be provided to indicate the status of testing, charging, failure, and normal operation. This indicator may be a display indicator integrated into the safety device for direct perception by a human user, or may be provided as a communication to one or more remote systems or devices.

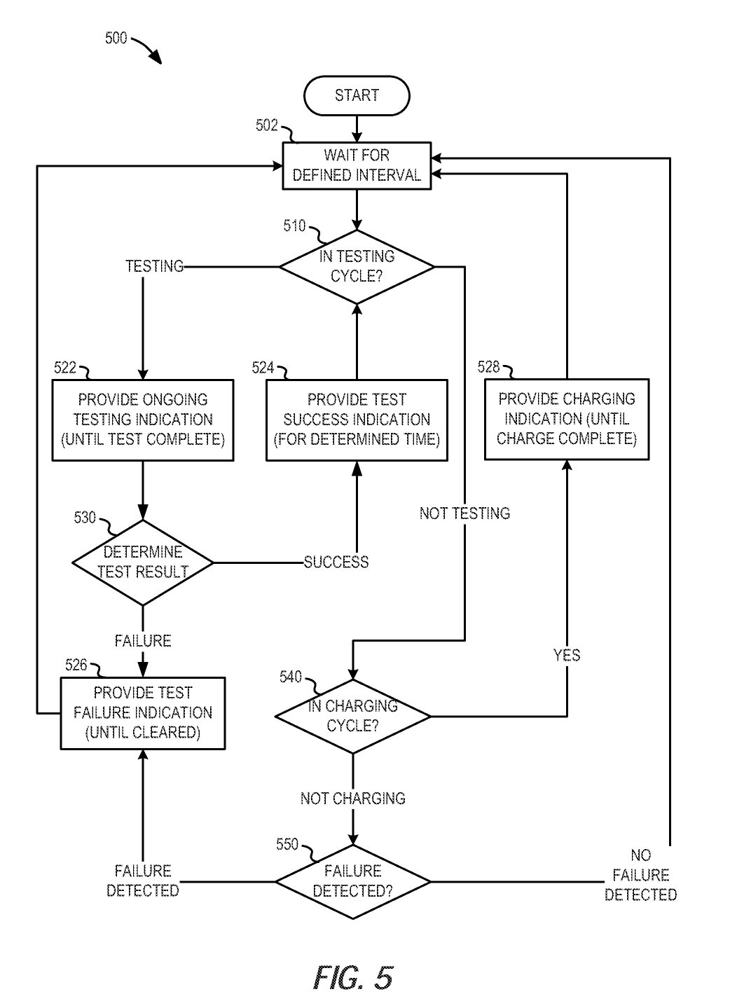

FIG. 5 provides an illustration of a flowchart for a series of verifications and operations (method 500) used to generate indicators in a safety device, according to some embodiments. These verifications may be used in conjunction with a variety of operational subsystems in a safety device. Thus, these verifications may be used for providing testing and charging indications relative to the testing and charging of a backup power source as described herein.

As shown, after a defined interval or period of time elapses (operation 502), a determination is made whether the safety device is in a testing cycle (decision 510). If the safety device is currently conducting testing, then the indicator is used to provide an ongoing testing indication, or like status indication, until the test is complete (operation 522). When the testing is complete, a determination is made for the result of the test (decision 530). If the test result is successful, then a test success indication is provided (operation 524) for a determined amount of time. If the test result is unsuccessful, then a test failure indication is provided (operation 526) until cleared. If the test or safety device encounters some error during operation of the test, then the same or a similar test failure indication (such as in operation 526) is likewise provided until cleared. When the test failure indication is cleared (such as by manual intervention from a user), the method 500 will resume to wait for a defined interval (operation 502) and repeat the determinations.

If the determination is made that the safety device is not in a testing cycle (decision 510) then further determinations are performed. As shown, a determination is made whether the safety device is currently in a charging cycle (decision 540) of the backup power source, and whether some failure condition has been detected for the safety device (decision 550).

If the safety device is currently in a charging cycle for its backup power source, then the indicator is used to provide a charging indication, or like status, until the charging operation or cycle is complete (operation 528). After the charging operation or cycle is complete, the safety device will proceed with waiting for the defined interval (operation 502) and repeat the series of determinations. If the safety device is not currently in a charging cycle for its backup power source, then an additional logic check is performed to verify operational status, and detect failure, of the safety device (decision 550). If failure is detected, then a failure indication, such as a test failure indication (operation 526) may be provided until cleared. If no failure is detected, then the safety device may proceed with waiting again for the defined interval (operation 502) and repeating the series of determinations.

In one example discussed herein, the indicator display may be provided by a LED lamp, such as a colored lamp. The LED lamp indicator may be configured to normally reside in a non-powered and non-lit “OFF” state, but become lit for at least a portion of time during one of the following conditions:

1) Battery is charging (blink short, 2 sec cycle)
2) Battery is absent (on solid)
3) Battery failed test (on solid)
4) Battery testing is underway (blinks, 2 sec cycle)
5) Automatic battery test succeeded (blink, 4 sec period, for 24 hrs)

Table 1 provides an illustration of LED operations in connection with various conditions in some embodiments.

TABLE 1

| Condition | LED Lamp Operation |
|---|---|
| AC Power is OFF | OFF |
| No Battery Detected | ON SOLID |
| Failed Battery Test | ON SOLID (user may reset) |
| Charging Battery | Blinks every 2 sec, 2% duty cycle |
| Battery testing - 30 second test | Blinks every 2 sec, 25% duty cycle |
| Battery testing - 90 minute test | Blinks every 2 sec, 85% duty cycle |
| Success of 30 second test | Blinks every 4 sec, 25% duty, 24 hours |
| Success of 90 minute test | Blinks every 4 sec, 85% duty, 24 hours |

### User-Initiated Backup Power Source Testing

Various controls (e.g., toggle switches, buttons, and the like) may be provided to receive user commands, and allow user control of testing or specialized operations of the safety device. For example, a backup power source “Test Button” may be a push button that is accessed through the plastic housing of the safety device near the LED indicator lamp.

The control may be used to manually initiate backup power source testing and clear errors or failure indications that are provided by the safety device (e.g., a battery testing error that made an LED indicator lamp turn on solid). When the battery is being tested, the safety device will be driven by the battery instead of being driven from the AC line power.

To manually initiate or control a battery test, a safety device may be configured to respond to user input as follows. To initiate a 30 second battery test, the test button may be depressed for 1-2 seconds to initiate a 30 second test procedure. The LED indicator lamp will blink at 25% duty cycle indicating a short test. To initiate a 90 minute battery test, the test button control may be depressed for 3-4 seconds to initiate a 90 minute test procedure. The LED indicator lamp will blink at 85% duty cycle indicating a short test. During testing, another short (e.g., less than 1 second) button press will terminate the testing and restart the battery recharge process. This may be useful if the user wishes to change the type of test being run, or abort the test. Thus, use of the test button control may allow a user to initiate manual battery testing at any time, in addition to the automatically scheduled testing.

If the indicator indicates an error (e.g., a LED indicator lamp is on solid, and is not blinking), the Test Button may be pressed to clear the error. For example, the device may be configured such that the user must press and hold the Test Button for a period of time, such as at least 5 seconds to clear the error (which changes the LED indicator lamp to indicate normal operation). The indicator also may be configured to indicate an error if the battery is removed or a battery switch to disable the backup power source is in the open position. Such types of errors may not be clearable.

The safety device may be configured to detect whether a primary power failure occurs during manual or automatic battery testing. In case of a power failure, the safety device stops the testing and operates in “battery backup” mode. The device will resume its normal operation (not in test mode) when the primary power is restored.

### Automatic Backup Power Source Testing

The safety device may provide automated testing of a backup power source. Executable logic provided in connection with a microcontroller may be used to track time in seconds, and initiate automatic backup power source testing of the battery or other secondary power source.

For example, the device may be configured to initiate an automatic battery test once a month (every 2.592 million seconds, i.e., every 30 days) during each year (e.g., every 360-365 days). After the first month, a full 90 minute test will be performed. During each of the next 11 months the system will perform a 30 second test. The 12 month pattern will repeat each year. In some embodiments, for simplicity, tests may be run every thirty (30) days, rather than to correspond to calendar dates. In some further embodiments, the clock may track certain calendar dates, to allow tests to recur during particular dates such as weekdays, and to avoid weekends, holidays, or other undesired testing dates.

The “clock” for 30-day testing may be started when the safety device first obtains AC power or backup power (e.g., when a battery on/off switch gets closed). The 30 day “clock” may be accurate within a particular amount of time, such as within 10 minutes a month. This should not be an issue since normally the responsible party will simply be verifying the testing indicator result during some time period (e.g., a 24 hour period) after the testing.

If the automatic test determines a successful test of the backup power source, the indicator will be used to provide a test success indication. For example, the LED indicator lamp may blink once every four seconds, for 24 hours. In some embodiments, this time period may be shortened or extended. After providing the test success indication, the LED indicator lamp will return to its normal indicator functions.

If the automatic test determines a failure of the backup power source, the LED indicator lamp will be used to provide a test failure indication. For example, the LED indicator lamp may be illuminated as solid to indicate battery failure. The LED indicator lamp may remain on solid until the user clears the error by pressing the Battery Test Button for a period of time, for example, at least 5 seconds. Battery replacement is recommended at this point. In some embodiments, the LED will remain illuminated solid until the battery replacement is detected.

Providing a positive indication of a successful battery testing may be performed within a time period after the automatic test, such as by checking the LED indicator lamp during the 24 hour window after an automatic test. For example, if the LED indicator lamp is blinking once every four seconds, then a user can verify that a successful test just occurred and can log a successful test.

Logic may be performed to prevent unintended execution of the automated testing operation. For example, the battery test may not start at exactly 30 days after the last test in cases where the battery is still charging from a significant drain. The battery test may be configured to abort if the battery voltage falls too low, or if the manual user interaction such as the Battery Test Button is pressed to stop the test.

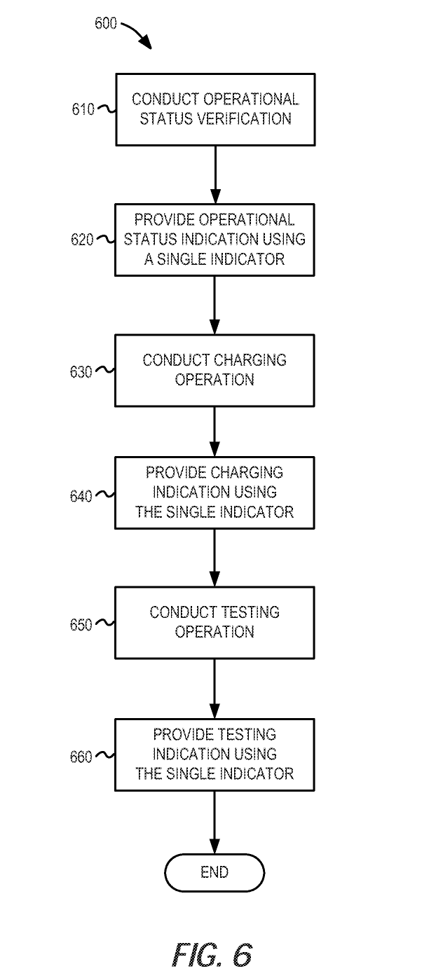

FIG. 6 provides a flowchart illustrating a method 600 for providing safety device indications according to an example embodiment. As shown, a series of operations performed in the safety device are accompanied by indicator displays. It will be understood that the sequence of operations and accompanying indicator displays are provided for purposes of illustration, as the operations and accompanying indicator displays may be repeated, substituted, or omitted from a particular method performed by the safety device.

As shown, operational status verification is conducted in the safety device (operation 610). This operational status may include various logic verifications, such as checking for the existence of any error codes, or executing specific checks in real-time. For example, if no error codes are collected in the safety device, then the operational status may be assumed to be successful. In response to the operational status verification, an operational status indication may be provided using a single indicator (operation 620). The operational status indication may be provided to not only display a failure indication, but also a success (e.g., system normal) operational status indication.

As also shown, charging operations are conducted with the backup power supply in the safety device (operation 630). The charging operations may result in the production of a success or error code. In response to the charging operations, a charging indication may be provided, either during the charging operations or after the charging operations, using the single indicator (operation 640). Thus, the charging indication may be provided to not only display a charge failure indication, but also a success or non-error condition of an ongoing, or completed charging operation.

As also shown, testing operations are conducted with the backup power supply in the safety device (operation 650). The testing operations may result in the production of a success or error code. In response to the testing operations, a testing indication may be provided using the single indicator (operation 660). The testing indication may be provided to not only display a test result failure indication, but also the success or non-error condition of an ongoing, or completed testing operation.

The previously described charging, testing, and operational techniques may be performed in conjunction with any number of modifications provided by human control or electronic processing systems and devices, and are not limited to the identical sequences or algorithms described herein. For examples, steps may be substituted, added, performed in a different order, or omitted from the examples described above and in the accompanying flowcharts.

Variations to the previously described safety device indicator and indicator lamp component may be provided, as safety device configurations provided according to the example embodiments are not limited to the use of one single-colored LED indicator lamp. For example, a multi-colored LED indicator lamp may be used to indicate various safety device statuses based on a displayed color or color combination. Likewise, other indicator displays may be provided by organic light emitting diode (OLED), liquid crystal displays (LCD), or incandescent lamps. In some embodiments, the indicator lamp may be integrated into a translucent control button, or may be provided separately to the safety device in connection with one or more coupled devices.

Although some of the previous examples were provided with reference to executing and outputting certain operations at the location of the safety device, it will be understood that such operations may be initiated or performed at a location remote to the safety device. In some embodiments, a safety device may be integrated with a communication network provided by a building monitoring, control, or automation system. Such a communication network may be facilitated by any number of wired (including power line), or wireless networking techniques (including machine-to-machine (M2M) networking). A building monitoring, control, or automation system may integrate with a variety of local or remote devices and computing systems, including other types of safety devices and non-safety devices.

Other applicable network configurations may be included within the scope of the presently described communication networks. It will be understood that networked communications may be facilitated using any number of personal area networks, local area networks (LANs), and wide area networks (WANs), using any combination of wired or wireless transmission mediums. The safety devices further may be configured to transmit communication signals to each other in variations of a device-to-device or peer-to-peer network.

Embodiments of the previously described safety device configurations and techniques may be implemented in one or a combination of hardware, firmware, and software. For example, instructions may be programmed in one or more semiconductor memory devices, and such semiconductor memory devices may be coupled to or integrated with a printed circuit board (PCB). The instructions may be replaced or supplemented for purposes of device re-programming, or alternatively the semiconductor memory devices or other hardware components may be replaced for device re-programming.

As described herein, a safety device may operate as a standalone machine or device or can be connected (e.g., networked) to other machines or devices. In a networked deployment, the machine can operate in the capacity of either a server or a client machine in server-client network environments, or it can act as a peer machine in peer-to-peer (or distributed) network environments. Further, while many embodiments described herein illustrate only a single machine or device, the terms “machine” or “device” shall also be taken to include any collection of machines or devices that individually or jointly execute a set (or multiple sets) of instructions to perform any one or more of the methodologies discussed herein.

Embodiments may also be implemented as instructions stored on at least one machine-readable storage device, which may be read and executed by at least one processor to perform the operations described herein. A machine-readable storage device may include any non-transitory mechanism for storing information in a form readable by a machine or device (e.g., a computer, standalone electronic device). For example, a machine-readable storage device may include read-only memory (ROM), random-access memory (RAM), magnetic disk storage media, optical storage media, flash-memory devices, and other storage devices and media. In some embodiments, the electronic devices and computing systems described herein may include one or more processors and may be configured with instructions stored on a computer-readable storage device.

While the machine-readable medium in one example embodiment is a single medium, the term “machine-readable medium” can include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

Machine-readable instructions can further be transmitted or received over a communications network using a transmission medium via the network interface device utilizing any one of a number of transfer protocols (e.g., HTTP). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the following, non-limiting configurations. Each of the following non-limiting examples can stand on its own, or can be combined in any permutation or combination with any one or more of the other examples provided below or throughout the present disclosure.

Example 1 includes a safety device apparatus, system, or device configuration, having: one or more powered components providing safety device functionality, the one or more powered components configured to operate with power from either of a primary power source or a backup power source, the backup power source configured to provide power to the one or more powered components upon interruption of power from the primary power source; a testing module configured to test operation of the one or more powered components using the backup power source and produce a test status, the testing module including processing circuitry to perform an automated test using the backup power source at a defined interval; and an indicator configured to display an operational status of the safety device and the test status of the automated test of the backup power source, wherein the operational status is indicated as either a success operational status or a failure operational status, and wherein the test status is indicated for a determined period of time as either a successful test result or a failed test result.

In Example 2, the subject matter of Example 1 can optionally include the one or more powered components providing an illuminated exit sign display, wherein the illuminated exit sign display is a Light Emitting Capacitor (LEC) display, an Electroluminescent (EL) display, a Light Emitting Diode (LED) display, or an Electronic Ink display.

In Example 3, the subject matter of one or any combination of Examples 1-2 can optionally include the backup power source including at least one rechargeable battery or capacitor.

In Example 4, the subject matter of one or any combination of Examples 1-3 can optionally include the safety device having an emergency light coupled to the primary power source and the backup power source, wherein the emergency light includes an incandescent light, a Light Emitting Diode (LED) light, a fluorescent light, or an induction light.

In Example 5, the subject matter of one or any combination of Examples 1-4 can optionally include the indicator being a single LED lamp configured to illuminate with a determined pattern corresponding to a status indication.

In Example 6, the subject matter of one or any combination of Examples 1-5 can optionally include a charging module configured to charge the backup power source in response to a determined condition, wherein the indicator is further configured to display a charging status.

In Example 7, the subject matter of one or any combination of Examples 1-6 can optionally include the determined conditions being one or more of: a daily charging event; a test of the backup power source: an interruption of power from the primary power source; or a detection of battery voltage below a determined threshold.

In Example 8, the subject matter of one or any combination of Examples 1-7 can optionally include a photo sensor to detect an amount of ambient light in an environment of the safety device; and a power consumption module operably coupled to the photo sensor, and configured to control power consumption of the one or more powered components providing safety device functionality based on the detected amount of ambient light in the environment of the safety device.

Example 9, can include, or can optionally be combined with the subject matter of one or any combination of Examples 1-8 to include providing an operational status indication with an indicator of the safety device, the operational status indication being indicated as either a success operational status or a failure operational status; performing, according to a determined charging interval, a charging operation for a backup power source of the safety device; providing a charging status indication with the indicator during and after the charging operation, the charging status indication being provided as either a successful charging result or a failed charging result; performing, according to a determined testing interval, a testing operation for the backup power source of the safety device; and providing a test status indication with the indicator during the testing operation and after the testing operation for a determined period of time, the test status indication being provided as either a successful test result or a failed test result.

In Example 10, the subject matter of Example 9 can optionally include the backup power source of the safety device including at least one rechargeable battery or capacitor.

In Example 11, the subject matter of one or any combination of Examples 9-10 can optionally include the indicator provided by the safety device being a single LED lamp configured to illuminate with a determined pattern corresponding to a status indication.

In Example 12, the subject matter of one or any combination of Examples 9-11 can optionally include the indicator being an audible indicator provided by the safety device and configured to provide an audible indication for a determined duration corresponding to a status indication.

In Example 13, the subject matter of one or any combination of Examples 9-12 can optionally include the determined charging interval providing for performing a charging operation daily or in response to: testing of the backup power source, interruption of power from the primary power source, or detection of battery voltage below a determined threshold.

In Example 14, the subject matter of one or any combination of Examples 9-13 can optionally include the determined testing interval providing for performing the testing operation for a 30-second test at least once every 30 days and for a 90-minute test at least once every 360 days.

In Example 15, the subject matter of one or any combination of Examples 9-14 can optionally include the safety device providing an illuminated exit sign display, wherein the illuminated exit sign display is a Light Emitting Capacitor (LEC) display, an Electroluminescent (EL) display, a Light Emitting Diode (LED) display, or an Electronic Ink display.

Example 16 can include, or can optionally be combined with the subject matter of one or any combination of Examples 1-15 to include at least one machine-readable storage medium providing instructions for execution with a processor of a safety device, having instructions to: provide an operational status indication with an indicator of the safety device, the operational status indication being indicated as either a successful operational status or a failure operational status; perform, according to a determined charging interval, a charging operation for a backup power source of the safety device; provide a charging status indication with the indicator during and after the charging operation, the charging status indication being provided as either a successful charging result or a failed charging result; perform, according to a determined testing interval, a testing operation for the backup power source of the safety device; and provide a test status indication with the indicator during the testing operation and after the testing operation for a determined period of time, the test status indication being provided as either a successful test result or a failed test result.

In Example 17, the subject matter of Example 16 can optionally include the indicator being a visible indicator provided by the safety device, and wherein the visible indicator is configured to illuminate with a determined pattern corresponding to a status indication.

In Example 18, the subject matter of one or any combination of Examples 16-17 can optionally include the determined charging interval being performed daily or in response to: testing of the backup power source, interruption of power from the primary power source, or detection of battery voltage below a determined threshold; and wherein the determined testing interval provides for performing the testing operation for a 30-second test at least once every 30 days and for a 90-minute test at least once every 360 days.

In Example 19, the subject matter of one or any combination of Examples 16-18 can optionally include the safety device providing an illuminated exit sign display, wherein the illuminated exit sign display is a Light Emitting Capacitor (LEC) display, an Electroluminescent (EL) display, a Light Emitting Diode (LED) display, or an Electronic Ink display.

In Example 20, the subject matter of one or any combination of Examples 16-19 can optionally include the at least one machine-readable storage medium being operably coupled to the safety device and providing the instructions for execution by a microprocessor of the safety device.

Example 21 can include, or can optionally be combined with the subject matter of one or any combination of Examples 1-20 to provide a safety device testing system, comprising: a safety device; a backup power source operably coupled to the safety device and configured to provide power to the safety device upon interruption of power from a primary power source; and an indicator operably coupled to the safety device; wherein the indicator is configured to provide a status indication of the safety device and the backup power source based on one or more operations, the one or more operations including: operations for testing performed with the backup power source, and operations for functional verification performed with the safety device; wherein the status indication is provided for a determined period of time as either a successful status indication or a failure status indication.

In Example 22, the subject matter of Example 21 can optionally include a charging component configured to charge the backup power source using power from the primary power source; wherein the indicator is further configured to provide the status indication of the charging component based on a charging operation performed by the charging component to charge the backup power source.

In Example 23, the subject matter of one or any combination of Examples 21-22 can optionally include the safety device being an illuminated exit sign device, an emergency lighting device, a smoke alarm, or a carbon monoxide alarm.

In Example 24, the subject matter of one or any combination of Examples 21-23 can optionally include the safety device being programmed to perform the testing operations, wherein the indicator is a visual indicator, and wherein the indicator provides distinguishing visual displays for either failure or success of the testing operations based on a failure or success result of the testing operations.

In Example 25, the subject matter of one or any combination of Examples 21-24 can optionally include the safety device being programmed to perform the functional verification operations, wherein the indicator is a visual indicator, and wherein the indicator provides distinguishing visual displays for either failure or success of the functional verification operations based on a failure or success result of the functional verification operations.

The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A safety device, comprising:
one or more powered components providing safety device functionality, the one or more powered components configured to operate with power from either of a primary power source or a backup power source, the backup power source configured to provide power to the one or more powered components upon interruption of power from the primary power source;
a testing module configured to test operation of the one or more powered components using the backup power source and produce a test status, the testing module including processing circuitry to perform an automated test using the backup power source at a defined interval; and
an indicator configured to display an operational status of the safety device and the test status of the automated test of the backup power source, wherein the operational status is indicated as either a success operational status or a failure operational status, and wherein the test status is indicated for a determined period of time as either a successful test result or a failed test result.

2. The safety device of claim 1, wherein the one or more powered components provide an illuminated exit sign display, and wherein the illuminated exit sign display is a Light Emitting Capacitor (LEC) display, an Electroluminescent (EL) display, a Light Emitting Diode (LED) display, or an Electronic Ink display.

3. The safety device of claim 1, wherein the backup power source includes at least one rechargeable battery or capacitor.

4. The safety device of claim 1, wherein the safety device includes an emergency light coupled to the primary power source and the backup power source, wherein the emergency light includes an incandescent light, a Light Emitting Diode (LED) light, a fluorescent light, or an induction light.

5. The safety device of claim 1, wherein the indicator is a single LED lamp configured to illuminate with a determined pattern corresponding to a status indication.

6. The safety device of claim 1, further comprising:
a charging module configured to charge the backup power source in response to a determined condition, wherein the indicator is further configured to display a charging status.

7. The safety device of claim 6, wherein the determined condition is one or more of: a daily charging event; a test of the backup power source; an interruption of power from the primary power source; or a detection of battery voltage below a determined threshold.

8. The safety device of claim 1, further comprising:
a photo sensor to detect an amount of ambient light in an environment of the safety device; and
a power consumption module operably coupled to the photo sensor, and configured to control power consumption of the one or more powered components providing safety device functionality based on the detected amount of ambient light in the environment of the safety device.

9. A method for providing status indications from a safety device, comprising:
providing an operational status indication with an indicator of the safety device, the operational status indication being indicated as either a success operational status or a failure operational status;
performing, according to a determined charging interval, a charging operation for a backup power source of the safety device;
providing a charging status indication with the indicator during and after the charging operation, the charging status indication being provided as either a successful charging result or a failed charging result;
performing, according to a determined testing interval, a testing operation for the backup power source of the safety device; and
providing a test status indication with the indicator during the testing operation and after the testing operation for a determined period of time, the test status indication being provided as either a successful test result or a failed test result.

10. The method of claim 9, wherein the backup power source of the safety device includes at least one rechargeable battery or capacitor.

11. The method of claim 9, wherein the indicator provided by the safety device is a single LED lamp configured to illuminate with a determined pattern corresponding to a status indication.

12. The method of claim 9, wherein the indicator is an audible indicator provided by the safety device and is configured to provide an audible indication for a determined duration corresponding to a status indication.

13. The method of claim 9, wherein the determined charging interval provides for performing a charging operation daily or in response to: testing of the backup power source, interruption of power from the primary power source, or detection of battery voltage below a determined threshold.

14. The method of claim 9, wherein the determined testing interval provides for performing the testing operation for a 30-second test at least once every 30 days and for a 90-minute test at least once every 360 days.

15. The method of claim 9, wherein the safety device provides an illuminated exit sign display, wherein the illuminated exit sign display is a Light Emitting Capacitor (LEC) display, an Electroluminescent (EL) display, a Light Emitting Diode (LED) display, or an Electronic Ink display.

16. At least one machine-readable storage medium providing instructions for execution with a processor of a safety device, comprising instructions to:
provide an operational status indication with an indicator of the safety device, the operational status indication being indicated as either a successful operational status or a failure operational status;
perform, according to a determined charging interval, a charging operation for a backup power source of the safety device;
provide a charging status indication with the indicator during and after the charging operation, the charging status indication being provided as either a successful charging result or a failed charging result;
perform, according to a determined testing interval, a testing operation for the backup power source of the safety device; and
provide a test status indication with the indicator during the testing operation and after the testing operation for a determined period of time, the test status indication being provided as either a successful test result or a failed test result.

17. The machine-readable storage medium of claim 16, wherein the indicator is a visible indicator provided by the safety device, and wherein the visible indicator is configured to illuminate with a determined pattern corresponding to a status indication.

18. The machine-readable storage medium of claim 16, wherein the determined charging interval is performed daily or in response to: testing of the backup power source, interruption of power from the primary power source, or detection of battery voltage below a determined threshold; and wherein the determined testing interval provides for performing the testing operation for a 30-second test at least once every 30 days and for a 90-minute test at least once every 360 days.

19. The machine-readable storage medium of claim 16, wherein the safety device provides an illuminated exit sign display, and wherein the illuminated exit sign display is a Light Emitting Capacitor (LEC) display, an Electroluminescent (EL) display, a Light Emitting Diode (LED) display, or an Electronic Ink display.

20. The machine-readable storage medium of claim 16, wherein the at least one machine-readable storage medium is operably coupled to the safety device and provides the instructions for execution by a microprocessor of the safety device.

21. A safety device testing system, comprising:
a safety device;
a backup power source operably coupled to the safety device and configured to provide power to the safety device upon interruption of power from a primary power source; and
an indicator operably coupled to the safety device;
wherein the indicator is configured to provide a status indication of the safety device and the backup power source based on one or more operations, the one or more operations including: operations for testing performed with the backup power source, and operations for functional verification performed with the safety device; wherein the status indication is provided for a determined period of time as either a successful status indication or a failure status indication.

22. The system of claim 21, further comprising:
a charging component configured to charge the backup power source using power from the primary power source;
wherein the indicator is further configured to provide the status indication of the charging component based on a charging operation performed by the charging component to charge the backup power source.

23. The system of claim 21, wherein the safety device is an illuminated exit sign device, an emergency lighting device, a smoke alarm, or a carbon monoxide alarm.

24. The system of claim 21, wherein the safety device is programmed to perform the testing operations, wherein the indicator is a visual indicator, and wherein the indicator provides distinguishing visual displays for either failure or success of the testing operations based on a failure or success result of the testing operations.

25. The system of claim 21, wherein the safety device is programmed to perform the functional verification operations, wherein the indicator is a visual indicator, and wherein the indicator provides distinguishing visual displays for either failure or success of the functional verification operations based on a failure or success result of the functional verification operations.
